(19) United States
(12) Patent Application Publication
(10) Pub. No.: US 2023/0322621 A1
(43) Pub. Date: Oct. 12, 2023

(54) CHAR BRICKS AND METHODS OF FABRICATION THEREOF

(71) Applicant: UNIVERSITY OF WYOMING, Laramie, WY (US)

(72) Inventor: Chooi Kim LAU, Laramie, WY (US)

(21) Appl. No.: 18/299,490

(22) Filed: Apr. 12, 2023

Related U.S. Application Data
(60) Provisional application No. 63/330,288, filed on Apr. 12, 2022.

(51) Int. Cl. C04B 18/06; C04B 28/02; C04B 14/06; C04B 40/00

(52) U.S. Cl. CPC C04B 18/065; C04B 28/02; C04B 14/06; C04B 40/0042; C04B 40/0067; C04B 2201/32; C04B 2201/20; C04B 2201/50; B28B 1/087

(57) ABSTRACT

Embodiments of the present disclosure relate to char bricks and methods of making char bricks. A composition (e.g., a char brick) includes about 0% to about 10% sand, about 30% to about 70% pyrolysis char (PC), and about 30% to about 60% cement. The PC has a particle size distribution from about 50 μm to about 500 μm. A method of making the composition includes mixing dry ingredients into a dry mixture, mixing the dry mixture with water to create a wet mixture; molding the wet mixture into a composition; and curing the composition. The dry ingredients include sand, pyrolysis char (PC), and cement. The PC has a particle size distribution from about 50 μm to about 500 μm.

### CROSS-REFERENCE TO RELATED APPLICATIONS

This application claims priority to U.S. Provisional Patent Application Ser. No. 63/330,288 filed on Apr. 12, 2022, which is incorporated herein by reference in its entirety.

### BACKGROUND

### Field

Embodiments of the present disclosure generally relate to methods and materials for fabricating bricks from coal. More specifically, embodiments of the present disclosure relate to materials and methods of forming pyrolysis char bricks.

### Description of the Related Art

Coal currently acts an important role as an energy source but the increasing demand for renewable energy has reduced the production and consumption of coal in the United States of America (USA). Coal is carbon-rich, and its use may affect CO₂ levels. The air pollution and global environmental issues associated with the combustion of coal have limited the continuous application of coal in energy production. Specifically, according to the Bureau of Safety and Environmental Enforcement (BSEE), global warming results from various greenhouse gas emissions is partly due to fossil fuel burning, such as the combustion of coal. Therefore, several studies are being conducted to create new non-energy and fuel opportunities for Wyoming coal.

Wyoming is rated as one of the major producers of coal in the USA. The Wyoming Powder River Basin (PRB) coal plays an important role in the Wyoming energy industry. However, renewable energy is slowly replacing the coal industry, causing the market price of coal to drop. Thus, to attract new investment through technological innovation and support Wyoming coal mine operations, this research studies the sustainability of environmentally friendly methods to create new diversified local industries of Wyoming coal. One concern is characterizing the eco-efficiency of the char products, which includes life-cycle metrics. In addition, the worldwide demand for bricks is rising, and is currently producing about 1,391 billion units.

Therefore, there is a need for improved bricks derived from coal and methods of fabrication thereof.

### SUMMARY

In one embodiment, a composition is disclosed. A composition includes about 0% to about 10% sand, about 30% to about 70% pyrolysis char (PC), and about 30% to about 60% cement. The PC has a particle size distribution from about 50 μm to about 500 μm.

In another embodiment, a method of fabricating a char brick is disclosed. The method includes mixing dry ingredients into a dry mixture, mixing the dry mixture with water to create a wet mixture; molding the wet mixture into a composition; and curing the composition. The dry ingredients include sand, pyrolysis char (PC), and cement. The PC has a particle size distribution from about 50 μm to about 500 μm.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only exemplary embodiments and are therefore not to be considered limited of its scope, and may admit to other equally effective embodiments.

FIG. 1 shows a flow diagram of a method of fabricating a pyrolysis char brick (PCB) according to at least one embodiment of the present disclosure.

FIG. 2 shows a flow diagram of a method of forming PC according to at least one embodiment of the present disclosure.

FIG. 2 is a graph of the X-Ray diffraction results for the PC according to at least one embodiment of the present disclosure.

FIG. 3 is a graph of the FTIR characteristics of PC according to at least one embodiment of the present disclosure.

FIG. 4 is an individualized graph of the FTIR characteristics of PC pyrolyzed at 850° C. according to at least one embodiment of the present disclosure.

FIG. 5 shows scanning electron microscopy (SEM) images of the PC according to at least one embodiment of the present disclosure.

FIG. 6 is a graph of the smoke density graph of PCBs according to at least one embodiment of the present disclosure.

FIG. 7 is a graph of the flame spread of the PCBs according to at least one embodiment of the present disclosure.

FIG. 8 is a graph of the temperature during the fire test according to at least one embodiment of the present disclosure.

FIG. 9 shows the product life cycle of clay brick according to at least one embodiment of the present disclosure.

FIG. 10 shows the product life cycle of PCBs according to at least one embodiment of the present disclosure.

To facilitate understanding, identical reference numerals have been used, where possible, to designate identical elements that are common to the figures. It is contemplated that elements and features of one embodiment may be beneficially incorporated in other embodiments without further recitation.

### DETAILED DESCRIPTION

Embodiments of the present disclosure generally relate to methods and materials for fabricating bricks from coal. More specifically, embodiments of the present disclosure relate to materials and methods of forming pyrolysis char bricks.

The inventors have found new and improved methods and materials for fabricating bricks from raw coal. Briefly, raw coal is thermo-chemically converted to produce pyrolysis char, and the resulting pyrolysis char is then converted to pyrolysis char bricks (PCBs).

The desire for environmentally-friendly materials, energy savings, and reduced energy consumption in building materials can be addressed by the building materials described herein. The building materials described herein have, e.g., reduced density, increased strength, reduced thermal conductivity and increased insulative properties when compared against conventional materials, such as clay bricks. These materials, through recycling/reuse and decreasing the amount of energy usage in fabrication, further lessens the environmental impact of the PCBs. At the end of its life, the building materials can be, e.g., recycled, pulverized, and/or reduced to soil amendment rather than landfilling. Thus, the environmental issues caused by the CO₂ emissions from the point of primary coal processing through the production of the building materials themselves are mitigated or eliminated, according to the embodiments described herein.

The use of headings is for purposes of convenience and does not limit the scope of the present disclosure. Embodiments described herein can be combined with other embodiments.

As used herein, a “composition” can include component(s) of the composition, reaction product(s) of two or more components of the composition, a remainder balance of remaining starting component(s), or combinations thereof. Compositions of the present disclosure can be prepared by any suitable mixing process.

### Compositions

Embodiments described herein generally relate to a composition, e.g., a pyrolysis char brick (PCBs), formed using pyrolysis char (PC). The PCBs can be formed using PC, cement, sand, and water. The PC, cement, and sand together make up a mixture of dry ingredients. The mixture of dry ingredients in about 30% to about 70% PC, about 0% to about 10% sand, and about 30% to about 60% cement, by weight. The cement acts as a binder. The cement includes ordinary Portland cement (OPC). The standard specifications for the cement can be found in ASTM C150. The sand may be coarse aggregate (e.g., a grain size from about 10 mm to about 63 mm in diameter) or fine aggregate (less than about 8 mm in diameter).

PC is a solid residue from a pyrolysis process of coal. The PC has a particle size distribution from about 50 μm to about 500 μm. The PC has a Brunauer, Emmett and Teller (BET) specific surface area of about 200 to about 300 m²/g, such as about 262 m²/g. The pore volume of the PC is from about 0.01 cm³/g to about 0.2 cm³/g. The heating value of the PC is from about 800° F. to about 900° F.

The PC includes elements such as carbon (C), magnesium (Mg), aluminum (Al), sulfur (S), and iron (Fe), among other elements. Carbon is the dominant material in the PC, while metal contents in the PC are at low levels. The chemical composition of the PC (weight/weight percent), using ultimate analysis, is about 1.0% to 1.1% nitrogen, about 75% to about 90% carbon, about 10% to about 20% oxygen, about 1.5% to about 2.5% hydrogen, and about 0.5% to about 1.1% sulfur. The chemical composition of the PC, using proximate analysis (weight/weight percent), is about 2.0% to about 3.5% water, about 13% to about 19% ash, and about 2.0% to about 3.0% volatile materials.

The PCBs have an initial rate of water absorption (IRA) from about 8 g/min/30 in² and about 15 g/min/30 in², such as about 11.5 g/min/30 in². According to ASTM C270, the IRA should be inside the range of 5 g/min/30 in² to 25 g/min/30 in². Exceeding this range would cause the water in the mortar to be extracted at a high rate, forming an incomplete bond.

The PCBs flame spread index (FSI) of about 0 feet and a smoke density index (SDI) of less than about 25. These values rate the PCBs as a Class “A” building material in accordance with the International Building Code (2006).

The compressive strength of the PCBs was from about 15 MPa to about 35 MPa, such as about 22 MPa. The density of the PCBs was between 1.3 g/cm³ and about 1.5 g/cm³. Conventional bricks have a density of about 2.18 g/cm³ and a compressive strength of about 9 MPa. The PCBs, therefore, are comparably lighter and stronger than conventional bricks.

The PCBs have a thermal conductivity was measured as less than 0.4 W/m·K, a thermal resistance R-value of between 0.2 and 0.4, a thermal transmittance U-value of 4.0 to about 4.5.

The PCB made using PC has comparable or superior performance in terms of mechanical properties, thermal resistance, weight, fire resistance, toxicity, electromagnetic radiation, and other qualities when compared to conventional bricks. Furthermore, a large quantity of pyrolysis char can be utilized in manufacturing the PCBs. The PCBs are suitable for constructing of buildings, dwellings, or other structures. Further still, the PCB has a reduced environmental impact when compared to conventional bricks.

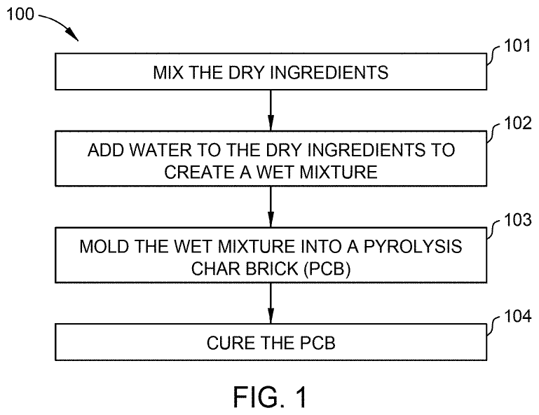

FIG. 1 is a flow diagram of a method 100 of fabricating a pyrolysis char brick (PCB). At operation 101, the dry ingredients are thoroughly mixed. The dry ingredients include cement, sand, and pyrolysis char (PC).

At operation 102, water is added to the dry mixture to create a wet mixture. The wet mixture includes about 20% to about 50% water by weight. A mixer may be used to prepare the wet mixture.

At operation 103, the wet mixture is molded into a pyrolysis char brick (PCB). A vibrating table may be used to remove air bubbles entrapped in the PCBs. Vibration may be performed for about 5 minutes to about 7 minutes.

At operation 104, the PCBs are cured. In one embodiment, the curing may be performed outdoors for about 25 days to about 35 days. In another embodiment, the curing operation may be performed from about 25° C. to about 45° C. in about 50% to about 100% humidity for about 10 days to about 20 days. The curing process does not require the use of an oven. The PCBs are about 7 inches to about 8 inches in length, about 3 inches to about 4 inches in width, and about 2 inches to about 3 inches is depth. However, PCBs of other sized are contemplated by this disclosure.

The process to manufacture conventional bricks requires the use of an oven, and thus energy to fuel the oven. By curing the PCBs without an oven, the energy costs and environmental impact of the curing operation is significantly reduced.

### Uses

Embodiments of the present disclosure also generally relate to uses of the compositions described herein. Compositions described herein can also be used for various applications.

Illustrative, but non-limiting, applications include concrete masonry units such as cinder blocks, breezeblocks, hollow blocks, concrete blocks, construction blocks, Besser blocks, clinker blocks, among other concrete masonry units.

The following examples are put forth so as to provide those of ordinary skill in the art with a complete disclosure and description of how to make and use embodiments of the present disclosure, and are not intended to limit the scope of embodiments of the present disclosure. Efforts have been made to ensure accuracy with respect to numbers used by some experimental errors and deviations should be accounted for.

### Examples

### Test Methods

The ultimate analysis of the PC is performed using ASTM D3176. The proximate analysis of the PC is performed using ASTM D3172.

The particle size of the PC is measured using a hydrometer, sieves, and stirring apparatus following ASTM D422-63

The bulk density of the PC is measured using a cylindrical container and tempting rod following ASTM C29/C29M-17a.

The thermal conductivity of the PC is measured using heat flow meter following ISO 8301: 1991 and ASTM C518-17. The heat flow meter was a Hot Disk TPS 1500.

The compressive strength of the PCB is measured using a hydraulic testing machine following ASTM C109.

The moisture buffering of the PCB is measured using a balance and constant-temperature testing chamber following ISO 24353: 2008 and ASTM C109M-16a.

The X-Ray Diffraction (XRD) is measured using a diffractometer from Rigaku Smartlab using Copper K-α radiation source operated at 40 kV and 40 mA.

The Fourier Transform Infrared Spectroscopy (FTIR) is measured using a FTIR machine from Thermo Scientific.

The Scanning Electron Microscopy (SEM) is measured using FEI Quanta 250 Conventional SEM.

The initial rate of absorption of the PCBs is measured using ASTM C67/C67M.

The fire test is performed using ASTM E-84/UL, 723/NFPA 255.

Thermal resistance and thermal transmittance were calculated from the thermal conductance, which is measured using a Hot Disk TPS 1500.

The building standards are in accordance with the International Building Code (2006).

Life Cycle Analysis was performed in accordance with ISO14040 (2006).

### Experimental

Table 1 is a summary of the results of the chemical and physical testing of the PC and PCBs. The bulk density of the PCBs is calculated by measuring the volume and mass. Compressive strength is determined by loading the specimens under displacement control until failure. The PC is characterized with SEM, FTIR, and BET analysis.

TABLE 1
Summary of Effectiveness of the Pyrolyzed Chars.

| Property | Pyrolyzed Char |
|---|---|
| Heating Value | 850° F. |
| Pore Volume (cm³/g) | 0.09 |
| BET Specific Surface Area (m²/g) | 262 |
| Elemental Composition | C, Mg, Al, S, Fe |

Table 2 is a particle size distribution of the PC. The particle size distribution of the PC is determined from four different PC samples taken from various locations of a char storage.

TABLE 2
Particle Size Distribution of PC.

| Char | | |
|---|---|---|
| Particle | | Average |
| Size | Composition | Composition |
| (μm) | (%) | (%) |
| >400 | 5-6 | 5.6 |
| 400 | 12-19 | 14.7 |
| 300 | 21-25 | 23.0 |
| 75 | 42-50 | 46.1 |
| <75 | 7-12 | 10.8 |

Table 3 shows the chemical composition of PC. The dominant material in the PC, carbon, is fixed while the metal content contained in the PC is at low levels. Therefore, PC satisfies the heavy metal limits for application as a building material, according to the LEED Target Volatile Organic Compounds (VOCs) standard set by the US Green Building Council LEED Operations and Maintenance v4 Performance Based Indoor Air Assessment in Existing Buildings Volatile Organic Compounds.

TABLE 3
Chemical Composition of the Raw Material PC.

| | Ultimate Analysist | | | | | Proximate Analysis | | |
|---|---|---|---|---|---|---|---|---|
| | (w/w %) | | | | | (w/w %) | | |
| Materials | N | C | O | H | S | H₂O | Ash | Volatile |
| PC (%) | 1.05 | 81.31 | 14.77 | 2.07 | 0.80 | 2.77 | 15.93 | 2.4 |

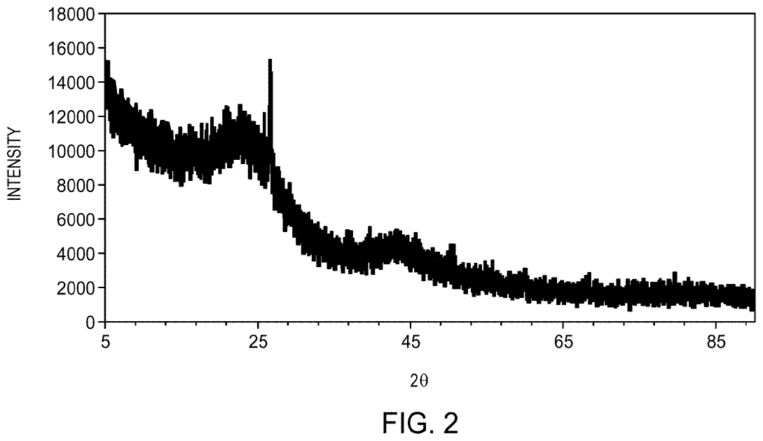

FIG. 2 is a graph of the X-Ray Diffraction (XRD) results for the PC. XRD is used to characterize the crystalline structures of PC. The XRD results indicates a peak, obtained at 20 of 26.55°, corresponding with graphite and silicon. Further elements observed within the XRD results are carbon, Sulphur, silicon, and nitrogen.

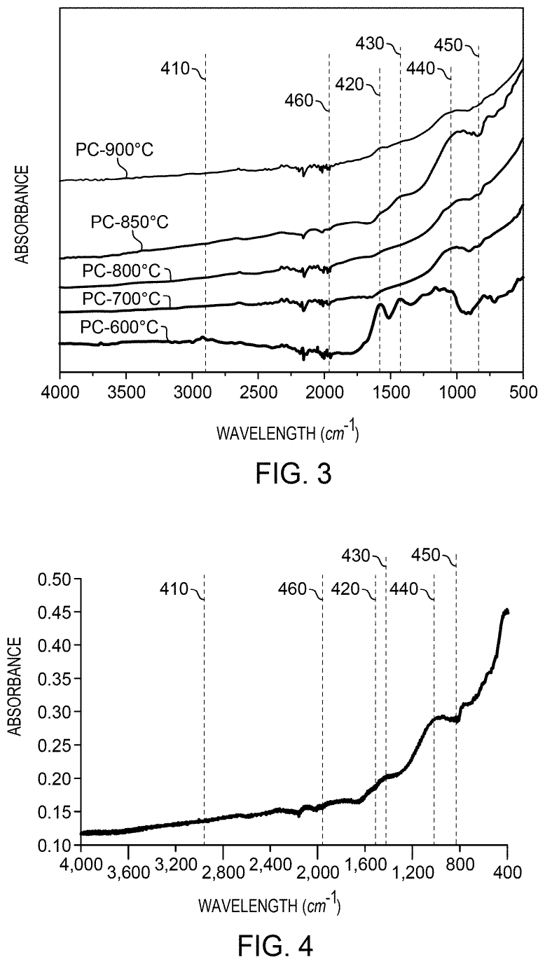

FIG. 3 is a graph of the Fourier-Transform Infrared Spectroscopy (FTIR) characteristics of PC. The FTIR is used to determine the functional groups present in the PC. The FTIR characteristics provide surface information about the PC. The decomposition and evaporation of organic matter causes the disappearance of the vibrational bonds and reduction in the intensity of the bands of the functional groups. The FTIR graph shows the results of PC pyrolyzed at temperatures of 600° C. (PC-600° C.), 700° C. (PC-700° C.), 800° C. (PC-800° C.), 850° C. (PC-850° C.), and 900° C. (PC-900° C.). FTIR is used to obtain an infrared spectrum of absorption or emission of solid, liquid, or gas. An FTIR spectrometer simultaneously collects high-resolution spectral data over a wide spectral range. FTIR uses the principle of characteristic fundamental vibrations to identify the molecular structure. FTIR spectroscopy measures the transition of the molecular vibration energy level through the absorption of the mid-IR vibration. IR spectroscopy is further measures the asymmetric vibration of polar groups.

The FTIR results for PC showed that the decomposition and evaporation of organic matter during the pyrolysis of coal cause the disappearance of the vibrational bonds and reduction in the intensity of the bands. The wavelength of around 2910 cm⁻¹ at axis 410 and around 1430 cm⁻¹ at axis 420 correspond to the stretching aliphatic CH and aliphatic CH bending, respectively. A peak is observed for the PC pyrolyzed at axis 410 and axis 420 for the PC-600° C. at both the stretching aliphatic CH and aliphatic CH bending. As the pyrolysis temperature increases (e.g., for PC-700° C., PC-800° C., PC-850° C., PC-900° C.), the peaks at the stretching aliphatic CH and aliphatic CH bending weaken or disappear due to greater decomposition of organic matter, which turns the carbon into graphite.

FIG. 4 is an individualized graph of the PC pyrolyzed at 850° C. The FTIR results also indicates a peak in intensity of 0.29 at axis 450 around a wavelength of 882 cm⁻¹. The band in this region shows the presence of C—O—C functional group found in cyclic anhydrides. There are two carbonyls in an anhydride due to two carbon atoms attaching to one oxygen atom. A stretched peak with an intensity of 0.29 was observed between wavelength of 910 cm⁻¹ and 1085 cm⁻¹. The C—H bending attached to the double bond of alkene group is found at a stretched peak wavelength of 1000 cm⁻¹ to 650 cm⁻¹. The vinylidene, cis and trans, are observed at 890±5 cm⁻¹, 690±50 cm⁻¹, 965±5 cm⁻¹. The observed peaks show out of plane C—H bends. The bands between the regions show C—H bond bending in the plane of the benzene ring. One of these bands, located at axis 440 around a wavelength 1035 cm⁻¹, shows the presence of benzene.

The FTIR results shows a stretched peak with an intensity of 0.20 with a wavelength around 1370 cm⁻¹ at axis 430 and around 1430 cm⁻¹ at axis 420. This stretch shows asymmetric methyl bending. Asymmetric bending shows the presence of CH₃ and CH₂. The peak at 1370 cm⁻¹ shows symmetric methyl bending which is referred to an umbrella mode. Aromatic rings have a series of weak bands in the 2000 cm⁻¹ to 1700 cm⁻¹ region that arises from overtones and combinations of lower wavelength vibrations. Benzene exhibits these bands at around 1959 cm⁻¹ at axis 460 and at around 1814 cm⁻¹. These patterns determine the substitution pattern on a benzene ring.

The FTIR results shows a stretched peak with an intensity of 0.17 with a wavelength of around 1620 cm⁻¹ and 1899 cm⁻¹. The stretched peak shows the double bond of an alkene group due to the ring modes of the aromatic spectra. Beyond this wavelength, a gentle decreasing slope is observed with bumps until 4000 cm⁻¹.

The BET method was used to calculate the specific surface area of the PC. The test is based on the nitrogen adsorption isotherm measurements greater than 100° C. The BET specific surface area was 262 m²/g, with average pore size of 1.4 nm, as shown in Table 4. The BET results are shown in Table 5.

TABLE 4
Summary of BET Test Results Conducted on PC.

| Properties | PC |
|---|---|
| BET Specific Surface Area (m²/g) | 262 |
| Pore Volume (cm³/g) | 0.09 |
| Average Pore Size (nm) | 1.4 |

TABLE 5
BET Results of PC.

| BET Specific Surface Area (m²/g) | | 262.1657 ± 2.1273 |
|---|---|---|
| Slope | | 0.37219 ± 0.00301 g/mmol |
| Y-Intercept | | −0.00006 ± 0.00020 g/mmol |
| C | | −5988.074414 |
| Qₘ | | 2.68725 mmol/g |
| Correlation Coefficient | | 0.9999017 |
| Molecular Cross-Sectional Area | | 0.1620 nm² |
| Relative | Quantity | |
| Pressure | Adsorbed | |
| (p/p°) | (mmol/g) | 1/[Q(p°/p − 1)] |
| 0.010368 | 2.64902 | 0.003955 |
| 0.031986 | 2.808293 | 0.01176 |
| 0.06736 | 2.911681 | 0.024805 |
| 0.079894 | 2.937881 | 0.029556 |
| 0.099875 | 2.97075 | 0.03735 |
| 0.010368 | 2.64902 | 0.003955 |
| 0.031986 | 2.808293 | 0.001766 |
| 0.06736 | 2.911681 | 0.024805 |
| 0.079894 | 2.937881 | 0.029556 |

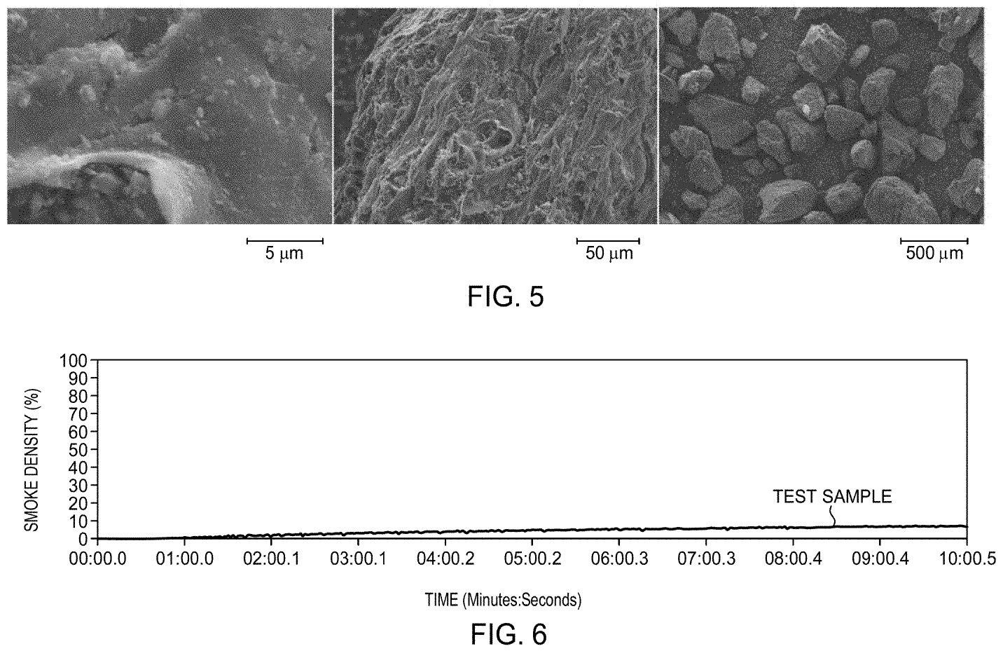

FIG. 5 shows scanning electron microscopy (SEM) images of the PC. The SEM images are the PC without cement. The SEM images provide information regarding the structure of the PC and information regarding the hydration abilities of PC and cement. The PC is shows few conchoidal fractures and bubbles, and includes mostly carbon (e.g., greater than 80%).

After the PC was used to mold PCBs, the PCBs were tested for material properties. Table 6 shows a summary of the composition and durability of the resultant PCBs.

TABLE 6
Composition and Durability of PCB.

| Technical Method | PCB |
|---|---|
| Material Composition | PC, cement, and sand |
| Density | 1.0-1.5 g/cm³ |
| Mechanical Compression | ≥14 MPa |
| Thermal Conductivity | <0.4 W/m · K |

Conventional bricks have a density of about 2.18 g/cm³. The PCBs, as shown in Table 6, have a density of 1.0-1.5 g/cm³. The PCBs show a 31% to 54% decrease in density from conventional bricks.

The thermal conductivity of the PCBs was conducted using two identical samples. Thermal conductivity measures the amount of heat energy that a material conducts. A throttle position sensor (TPS) was placed in between the samples. The samples were compressed to reduce resistance. The samples were heated using the TPS and the thermal response was monitored using the TPS. The thermal conductivity was measured as less than 0.4 W/m·K, as shown in Table 6. Conventional bricks have a thermal conductivity of 0.983 W/m·K. By having a lower thermal conductivity than conventional bricks, the PCBs are less heat conductive, and therefore more suitable as building materials.

The PCBs were tested for compressive strength. A total of 32 PCB samples from the 400 piece manufacturing set of PCBs were chosen to be tested. The formula for the strength of the PCBs is shown in Equation 1:

$$Compresion Strength of Brick = \frac{N}{{A}_{A}}$$

Where N is the max load at failure in Newtons (N) and A_{A} is the average area (mm²). The compressive strength was measured at 7 days, 14 days, and 28 days of curing. Table 7 shows the results of the compressive strength testing. The average 28 days compressive strength was around 22 MPa.

TABLE 7
Compressive Test Results.

| | Compressive Strength | | |
|---|---|---|---|
| Batch | (MPa) | | |
| Number | 7 Days | 14 Days | 28 Days |
| 500 | 12.9 | 15.8 | 21.7 |
| 1000 | 12.5 | 17.6 | 17.7 |
| 1500 | 12.8 | 17.5 | 18.0 |
| 2000 | 13.0 | 18.5 | 22.7 |
| 1500 | 12.6 | 16.5 | 22.2 |
| 2500 | 15.4 | 16.6 | 22.2 |
| 3000 | 12.7 | 18.4 | 22.2 |
| 3500 | 16.3 | 19.3 | 22.5 |
| 4000 | 11.8 | 17.2 | 18.6 |

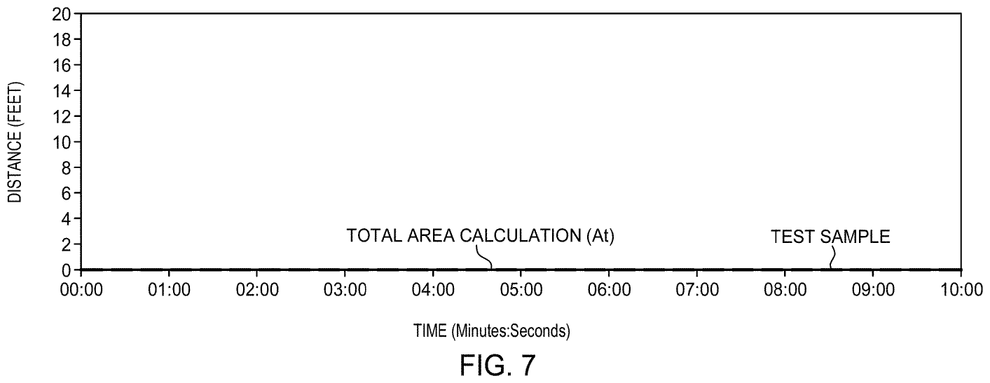

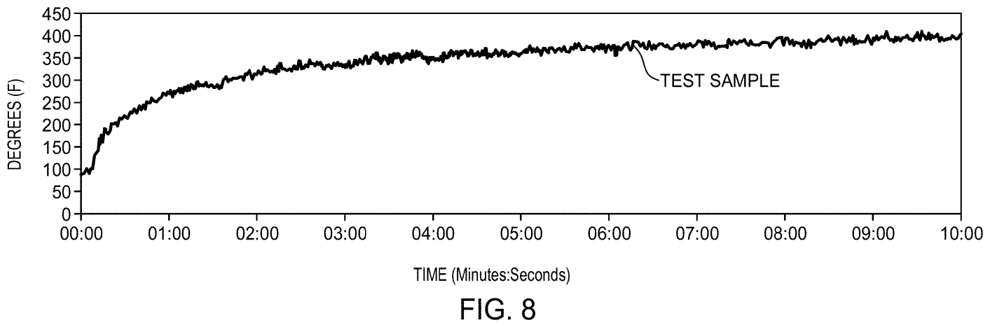

FIG. 6 is a graph of the smoke density graph of PCBs. FIG. 7 is a graph of the flame spread of the PCBs. FIG. 8 is a graph of the temperature during the fire test. A total of 220 char bricks were fire tested. The fire testing includes a smoke density test and a flame spread test. The test results show that the PCBs has a flame spread of 0 feet and a smoke density less than 25. This qualifies the PCBs as a Class “A” building material.

After performing the fire testing, the samples were tested for compression strength. The results showed that the strength of the PCBs remained around 22 MPa, as shown with the non-fire tested samples.

TABLE 11
Compressive Test Results.

| | | Compressive |
|---|---|---|
| | Density | Strength |
| Sample | (g/cm³) | (MPa) |
| 1 | 1.39 | 21.99 |
| 2 | 1.37 | 29.81 |
| 3 | 1.41 | 24.27 |

Conventional bricks have a compressive strength of about 9 MPa. The PCBs show a strength increase of approximately 144% over the conventional bricks, even after fire testing. The increased strength and decreased density of the PCBs over conventional bricks results in a significant decrease in transportation costs, as will be discussed below, without a subsequent degradation in the stability of the structure to be built from the PCBs.

Initial rate of absorption tests were conducted to determine the workability of the PCBs. The rate of extraction determines how well the mortar will bond to the PCBs. The PCBs were prepared by heating in a furnace at 225° F. for 24 hours with 2 hour intervals until there is less than 0.2% of weight loss change. The PCBs are then removed and placed in a cool down machine that humidifies at 75° F. with a humidity between 30% and 70% for 4 hours. All the PCBs are weighed after the cool down process. The PCBs are placed on metal supports and distilled water is added until the water reaches ⅛ inch above the metal supports. The PCBs sit in the water for 1 minute. The PCBs are removed and excess, e.g. dripping, water is wiped away. The PCBs are weighed within 2 minutes. The initial rate of absorption results are shown in Table 8.

TABLE 8
Initial Rate of Absorption Results.

| | | | | | Percentage |
|---|---|---|---|---|---|
| | | | | | of water |
| | | | | 1 minute | gained |
| | | Dry | Wet | initial rate of | to brick |
| | Dimensions | Weight | Weight | absorption | weight in |
| Specimen | (L × B) | (lb.) | (lb.) | (g/min/30 in²) | 1 minute |
| Brick 1 | 7.56 × 3.51 | 2.385 | 2.41 | 12.82 | 1.05% |
| Brick 2 | 7.56 × 3.51 | 2.4 | 2.42 | 10.25 | 0.83% |

| | | | | |
|---|---|---|---|---|
| Average | 2.3925 | 2.415 | 11.535 | 0.94% |

The calculations for the initial rate of absorption test are calculated using Equation 2:

$$I R A = \frac{( 30 \times W )}{L \times B}$$

Where IRA is the initial rate of absorption, W is the weight gain, L is the length of the brick, and B is the width of the brick. The dry weight and the wet weight were subtracted to find W.

ASTM C270 standard specification for mortar stipulates that mortar bonds best with IRAs of 5 to 25 g/min/30 in². If the extraction is higher than 25 g/min/30 in², the water in the mortar would be extracted at a high rate and form an incomplete bond. As shown in the IRA results, the PCBs fell within the acceptable range, having an average IRA of 11.5 g/min/30 in². Thus, PCBs fall within the ASTM standards for building materials.

A life cycle assessment (LCA) was performed on the PCBs. The LCA method of the product from resource extraction and manufacturing (cradle) to the end of life (grave), such as disposal or recycling, was analyzed to aid in the evaluation of human toxicity and ecotoxicity. This method is utilized to discover pollutants among air, water, and soil originating from the product. The method calculates and classifies the energy and wastes released into the environment, and the materials used in the design of the product.

Table 9 shows a comparison of properties between PCBs and clay bricks.

TABLE 9
Comparison of Properties between PCBs and Clay Bricks.

| Brick | Char | Clay |
|---|---|---|
| Cost Per Brick ($) | 0.335 | 0.90 |
| Minimum Weight (lbs.) | 2.079 | 4.86 |
| Size (in × in × in) | 2.25 × 3.625 × 7.625 | 2.25 × 3.625 × 7.625 |
| Density (g/cm³) | 1.0-1.5 | 2.18 |
| Compressive Strength (MPa) | 24 | 9 |
| Thermal Conductivity | <0.4 | 0.983 |
| (W/m · K) | | |
| Thermal Resistance (R) | 0.27 | 0.09 |
| Thermal Transmittance | 3.7 | 11.11 |
| (U-Value)(W/(m² · k)) | | |

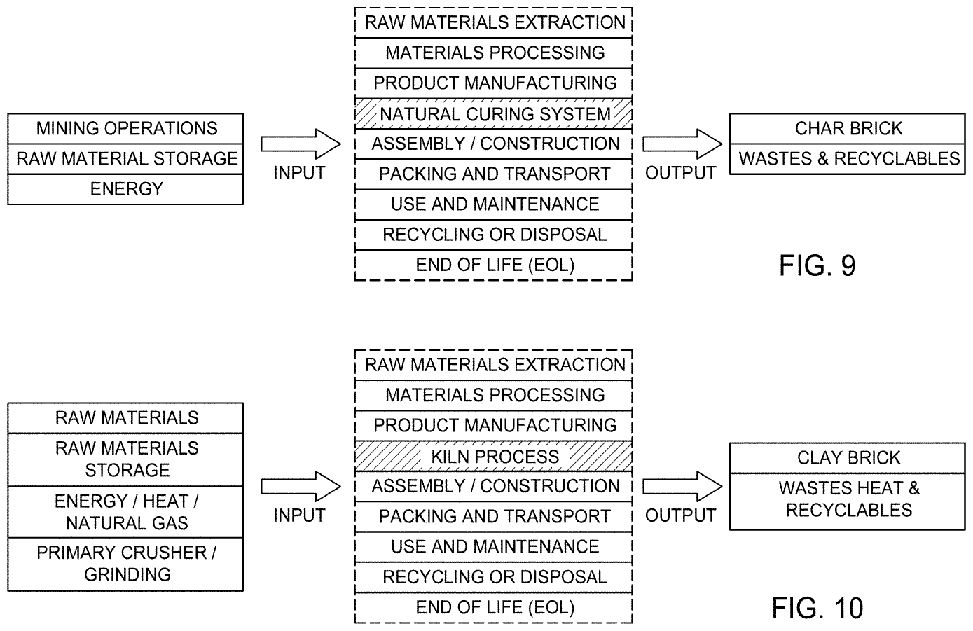

FIG. 9 shows the product life cycle of clay bricks. Normally, clay bricks are produced from clay with high temperature kiln firing. A dryer process is used separate from the kiln. The dryer process is typically performed at about 400° F. using heat produced from gas or other fuels from the local grid. Most common kilns are about 340 ft to about 500 ft and include a preheating zone, a firing zone, and a cooling zone. The firing zone is maintained around 2000° F. Natural gas, vaporized propane, coal, and sawdust are the most commonly used materials for firing conventional clay bricks. The entire drying, firing, and cooling process takes around 50 hours. After firing, the brick is relocated to a cooling zone until the temperature reaches near ambient temperatures before being stored and shipped.

High temperature kiln firing consumes a significant amount of energy, releasing large quantities of greenhouse gases. Clay bricks, on average, have an embodied energy of approximately 2.0 kWh and release 0.41 kg of carbon dioxide per brick. In addition, obtaining clay from quarrying is labor and energy intensive, adversely affects the landscape, and generates high levels of waste.

Concrete bricks and blocks are produced using OPC and various aggregates. OPC production is a very energy intensive process and releases significant amounts of greenhouse gases. 1 kg of OPC produced requires 1.5 kWh of energy and released 1 kg of carbon dioxide into the atmosphere. Globally, OPC production contributes to ˜7% of all carbon dioxide generated. Cement production processes account for ˜90% of total carbon dioxide produced. The aggregates are produced using quarrying and thus have similar logistical and environmental problems as described above for clay.

FIG. 10 shows the product life cycle of PCBs. PCBs utilize natural air-dry curing, meaning that no kiln is required to manufacture PCBs. This process maintains a zero-waste management re-use and recycle system, as well as reduced residual materials in the process. The only energy applied to the production of PCBs is a concrete mixer machine and vibrating machine. Since the PCBs are composed of PC, at the end of their life cycle, through either damage or age, the PCBs can be recycled back into its fundamental building materials. This contributes to reducing the negative environmental and energy usage impacts by as much as 30%-50%.

Transportation of bricks from the brick factory to the building site is typically less than 50 miles. Transportation occurs mainly using trucks and rail. This distance would be unchanged between char bricks or conventional clay bricks. However, as noted above, the significant decrease in the density of char bricks compared to conventional clay bricks results in decreased emissions from in transportation, lessening the environmental impacts.

Thermal resistance is calculated from the thermal conductivity. A higher R value for a material is better, as it results in less energy loss. As seen in Table 9, the thermal resistance of char bricks is greater than that of conventional clay bricks, resulting in less energy loss.

The thermal transmittance is calculated from the thermal conductivity. Materials with lower U-value have greater insulative effects. The U-value of the char bricks is lower than that of conventional clay bricks, resulting in the char bricks having greater insulative properties.

As is apparent from the foregoing general description and the specific aspects, while forms of the aspects have been illustrated and described, various modifications can be made without departing from the spirit and scope of the present disclosure. Accordingly, it is not intended that the present disclosure be limited thereby. Likewise, the term “comprising” is considered synonymous with the term “including.” Likewise whenever a composition, process operation, process operations, an element or a group of elements is preceded with the transitional phrase “comprising,” it is understood that we also contemplate the same composition or group of elements with transitional phrases “consisting essentially of,” “consisting of,” “selected from the group of consisting of,” or “Is” preceding the recitation of the composition, process operation, process operations, element, or elements and vice versa, such as the terms “comprising,” “consisting essentially of,” “consisting of” also include the product of the combinations of elements listed after the term.

For purposes of this present disclosure, and unless otherwise specified, all numerical values within the detailed description and the claims herein are modified by “about” or “approximately” the indicated value, and consider experimental error and variations that would be expected by a person having ordinary skill in the art. For the sake of brevity, only certain ranges are explicitly disclosed herein. However, ranges from any lower limit may be combined with any upper limit to recite a range not explicitly recited, as well as, ranges from any lower limit may be combined with any other lower limit to recite a range not explicitly recited, in the same way, ranges from any upper limit may be combined with any other upper limit to recite a range not explicitly recited. For example, the recitation of the numerical range 1 to 5 includes the subranges 1 to 4, 1.5 to 4.5, 1 to 2, among other subranges. As another example, the recitation of the numerical ranges 1 to 5, such as 2 to 4, includes the subranges 1 to 4 and 2 to 5, among other subranges. Additionally, within a range includes every point or individual value between its end points even though not explicitly recited. For example, the recitation of the numerical range 1 to 5 includes the numbers 1, 1.5, 2, 2.75, 3, 3.80, 4, 5, among other numbers. Thus, every point or individual value may serve as its own lower or upper limit combined with any other point or individual value or any other lower or upper limit, to recite a range not explicitly recited.

While the foregoing is directed to embodiments of the present disclosure, other and further embodiments of the disclosure may be devised without departing from the basic scope thereof.

What is claimed is:

1. A composition, the composition comprising:
about 0% to about 10% sand;
about 30% to about 70% pyrolysis char (PC), the PC having a particle size distribution from about 50 μm to about 500 μm; and
about 30% to about 60% cement.

2. The composition of claim 1, wherein the composition has a Brunauer, Emmett and Teller (BET) specific surface area of about 200 to about 300 m²/g, such as about 262 m²/g.

3. The composition of claim 1, wherein a pore volume of the PC is from about 0.01 cm³/g to about 0.2 cm³/g.

4. The composition of claim 1, wherein the composition have an initial rate of water absorption (IRA) from about 8 g/min/30 in² and about 15 g/min/30 in², such as about 11.5 g/min/30 in².

5. The composition of claim 1, wherein the composition has a flame spread index (FSI) of about 0 feet and a smoke density index (SDI) of less than about 25.

6. The composition of claim 1, wherein a compressive strength of the composition was from about 15 MPa to about 35 MPa.

7. The composition of claim 1, wherein a density of the composition is from about 1.0 to about 1.5 g/cm³.

8. The composition of claim 1, wherein a thermal conductivity of the composition is less than 0.4 W/m·K.

9. The composition of claim 1, wherein the composition has a thermal resistance R-value of between 0.2 and 0.4.

10. The composition of claim 1, wherein the composition has a thermal transmittance U-value of 4.0 to about 4.5.

11. A method of making a composition, the method comprising:
mixing dry ingredients into a dry mixture, the dry ingredients comprising sand, pyrolysis char (PC), and cement, wherein the PC has a particle size distribution from about 50 μm to about 500 μm;
mixing the dry mixture with water to create a wet mixture;
molding the wet mixture into a composition; and
curing the composition.

12. The method of claim 11, further comprising vibrating the wet mixture during molding.

13. The method of claim 11, wherein the curing is performed at ambient conditions for about 25 days to about 35 days.

14. The method of claim 11, wherein the curing is performed from about 25° C. to about 45° C. in about 50% to about 100% humidity for about 10 days to about 20 days.

15. The method of claim 11, wherein a compressive strength of the composition was from about 15 MPa to about 35 MPa.

16. The method of claim 11, wherein the composition has a Brunauer, Emmett and Teller (BET) specific surface area of about 200 to about 300 m²/g, such as about 262 m²/g.

17. The method of claim 11, wherein the composition has a flame spread index (FSI) of about 0 feet and a smoke density index (SDI) of less than about 25.

18. The method of claim 11, wherein a density of the composition is from about 1.0 to about 1.5 g/cm³.

19. The method of claim 11, wherein a thermal conductivity of the composition is less than 0.4 W/m·K.

20. The method of claim 11, wherein a pore volume of the PC is from about 0.01 cm³/g to about 0.2 cm³/g.
